(19) United States
(12) Patent Application Publication
(10) Pub. No.: US 2010/0274515 A1
(43) Pub. Date: Oct. 28, 2010

(54) Dynamic Analyte Sensor Calibration Based On Sensor Stability Profile

(75) Inventors: Udo Hoss, Castro Valley, CA (US); John Charles Mazza, Pleasanton, CA (US)

Correspondence Address: JACKSON & CO., LLP, 6114 LA SALLE AVENUE, #507, OAKLAND, CA, 94611-2802, US

(73) Assignee: Abbott Diabetes Care Inc., Alameda, CA (US)

(21) Appl. No.: 12/769,639

(22) Filed: Apr. 28, 2010

Related U.S. Application Data
(60) Provisional application No. 61/173,593, filed on Apr. 28, 2009.

(51) Int. Cl. G06F 19/00

(52) U.S. Cl. 702/104

(57) ABSTRACT

Dynamic sensor calibration schedule management including determining a stability profile of an in vivo analyte sensor in fluid contact with a biological fluid, processing the determined stability profile in conjunction with calibration criteria for the analyte sensor, and modifying a predetermined sensor calibration schedule based on the processed stability profile is provided.

### RELATED APPLICATIONS

The present application claims priority under 35 U.S.C. §119(e) to U.S. provisional application No. 61/173,593 filed Apr. 28, 2009, entitled “Dynamic Analyte Sensor Calibration Based On Sensor Stability Profile”, the disclosure of which is incorporated in its entirety by reference for all purposes.

### BACKGROUND

There are a number of instances when it is desirable or necessary to monitor the concentration of an analyte, such as glucose, lactate, or oxygen, for example, in bodily fluid of a body. For example, it may be desirable to monitor high or low levels of glucose in blood or other bodily fluid that may be detrimental to a human. In a healthy human, the concentration of glucose in the blood is maintained between about 0.8 and about 1.2 mg/mL by a variety of hormones, such as insulin and glucagons, for example. If the blood glucose level is raised above its normal level, hyperglycemia develops and attendant symptoms may result. If the blood glucose concentration falls below its normal level, hypoglycemia develops and attendant symptoms, such as neurological and other symptoms, may result. Both hyperglycemia and hypoglycemia may result in death if untreated. Maintaining blood glucose at an appropriate concentration is thus a desirable or necessary part of treating a person who is physiologically unable to do so unaided, such as a person who is afflicted with diabetes mellitus.

Certain compounds may be administered to increase or decrease the concentration of blood glucose in a body. By way of example, insulin can be administered to a person in a variety of ways, such as through injection, for example, to decrease that person's blood glucose concentration. Further by way of example, glucose may be administered to a person in a variety of ways, such as directly, through injection or administration of an intravenous solution, for example, or indirectly, through ingestion of certain foods or drinks, for example, to increase that person's blood glucose level.

Regardless of the type of adjustment used, it is typically desirable or necessary to determine a person's blood glucose concentration before making an appropriate adjustment. Typically, blood glucose concentration is monitored by a person or sometimes by a physician using an in vitro test that requires a blood sample. The person may obtain the blood sample by withdrawing blood from a blood source in his or her body, such as a vein, using a needle and syringe, for example, or by lancing a portion of his or her skin, using a lancing device, for example, to make blood available external to the skin, to obtain the necessary sample volume for in vitro testing. The fresh blood sample is then applied to an in vitro testing devices such as an analyte test strip, whereupon suitable detection methods, such as calorimetric, electrochemical, or photometric detection methods, for example, may be used to determine the person's actual blood glucose level. The foregoing procedure provides a blood glucose concentration for a particular or discrete point in time, and thus, must be repeated periodically, in order to monitor blood glucose over a longer period.

Conventionally, a “finger stick” is generally performed to extract an adequate volume of blood from a finger for in vitro glucose testing since the tissue of the fingertip is highly perfused with blood vessels. These tests monitor glucose at discrete periods of time when an individual affirmatively initiates a test at a given point in time, and therefore may be characterized as “discrete” tests. Unfortunately, the fingertip is also densely supplied with pain receptors, which can lead to significant discomfort during the blood extraction process. Unfortunately, the consistency with which the level of glucose is checked varies widely among individuals. Many diabetics find the periodic testing inconvenient and they sometimes forget to test their glucose level or do not have time for a proper test. Further, as the fingertip is densely supplied with pain receptors which causes significant discomfort during the blood extraction process, some individuals will not be inclined to test their glucose levels as frequently as they should. These situations may result in hyperglycemic or hypoglycemic episodes.

In addition to the discrete or periodic, in vitro, blood glucose monitoring systems described above, at least partially implantable, or in vivo, glucose monitoring systems, which are designed to provide continuous or semi-continuous in vivo measurement of an individual's glucose concentration. A number of these in vivo systems are based on “enzyme electrode” technology, whereby an enzymatic reaction involving an enzyme such as glucose oxidase, glucose dehydrogenase, or the like, is combined with an electrochemical sensor for the determination of an individual's glucose level in a sample of the individual's biological fluid. By way of example, the electrochemical sensor may be placed in substantially continuous contact with a blood source, e.g., may be inserted into a blood source, such as a vein or other blood vessel, for example, such that the sensor is in continuous contact with blood and can effectively monitor blood glucose levels. Further by way of example, the electrochemical sensor may be placed in substantially continuous contact with bodily fluid other than blood, such as dermal or subcutaneous fluid, for example, for effective monitoring of glucose levels in such bodily fluid, such as interstitial fluid.

Relative to discrete or periodic monitoring using analyte test strips, subcutaneous continuous monitoring is generally more desirable in that it may provide a more comprehensive assessment of glucose levels and more useful information, including predictive trend information, for example. Subcutaneous continuous glucose monitoring is also desirable as it is typically less invasive than discrete or periodic glucose monitoring in blood accessed from a blood vessel.

Regardless of the type of implantable analyte monitoring device employed, it has been observed that transient, low sensor readings which result in clinically significant sensor related errors may occur for a period of time. For example, it has been found that during the initial 12-24 hours of sensor operation (after implantation), a glucose sensor's sensitivity (defined as the ratio between the analyte sensor current level and the blood glucose level) may be relatively low—a phenomenon sometimes referred to as “early signal attenuation” (ESA). Additionally, low sensor readings may be more likely to occur at certain predictable times such as during night time use—commonly referred to as “night time drop outs”. An in vivo analyte sensor with lower than normal sensitivity may report blood glucose values lower than the actual values, thus potentially underestimating hyperglycemia, and triggering false hypoglycemia alarms.

Spurious low readings or drop outs may be caused by the presence of blood clots also known as “thrombi” that form as a result of insertion of the sensor in vivo. Such clots exist in close proximity to a subcutaneous glucose sensor and have a tendency to “consume” glucose at a high rate, thereby lowering the local glucose concentration. It may also be that the implanted sensor constricts adjacent blood vessels thereby restricting glucose delivery to the sensor site.

While these transient, low readings are infrequent and, in many instances, resolve after a period of time, the negative deviations in sensor readings impose constraints upon analyte monitoring during the period in which the deviations are observed. One manner of addressing this problem is to configure the analyte monitoring system so as to delay reporting readings to the user until after this period of negative deviations passes. Another way of addressing negative deviations in sensor sensitivity is to require frequent calibration of the sensor. This is often accomplished in the context of continuous glucose monitoring devices by using a reference value after the sensor has been positioned in the body, where the reference value most often employed is obtained by a finger stick and use of a blood glucose test strip.

Notwithstanding the environmental effects on the sensitivity of subcutaneously implanted sensors in general, continuous analyte monitoring sensors designed according to identical specifications and fabricated by the same processes and equipment may have variations in sensitivity, e.g., variations in sensitivity amongst sensors of the same lot or batch and/or between sensors of different lots. The variations may be due to inconsistency in the registration of the material layers, i.e., misalignment of the layer edges relative to each other. Additionally, inconsistencies in the volume/area of the various materials as they are being deposited or dispensed may occur. Still yet, inconsistencies in the spatial resolution or edge definition of the various materials on the substrate can cause variations in sensitivity.

Due to these registration, deposition and resolution inconsistencies, in certain instances, some form of calibration may be required prior to use of the sensor to measure analyte, and/or oftentimes a user may also need to perform a number of calibrations during the time period that the sensor is used. One way this “individual-specific calibration” is accomplished is by calibrating a continuous analyte sensor against a reference value after the sensor has been positioned in the body of a user, where the reference value most often used by users of continuous glucose monitoring devices is a blood glucose test strip. Typically, glucose monitoring systems' calibration time periods may be predetermined and based on a fixed schedule during sensor use. When successful sensor calibration is not performed, the system may no longer display or output real time or substantially real time monitored glucose levels.

Such calibration schedule may increase the level of inconvenience to the user or sub-optimal use of the monitoring system, where missed calibration event during the sensor wear results in the system temporality or permanently shutting down until sensor is calibrated. For example, when the calibration schedule is fixed and is determined from when the sensor is first positioned in contact with the user's analyte, and the calibration time period falls when it is not convenient or practical to the user, the convenience of the analyte monitoring system may be diminished. That is, depending on when the sensor is first inserted through the skin layer of the patient and initialized for operation (e.g. analyte monitoring), the scheduled calibration time period may fall at night time (for example, when the user is sleeping), or during the day, but when the user is not able to perform the in vitro blood glucose testing to calibrate the sensor (for example, when in meetings, engaged in physical or other activities, and the like).

### SUMMARY

1. Embodiments include a method comprising determining a stability profile of an in vivo analyte sensor in fluid contact with a biological fluid, determining the stability profile including, detecting the onset of a calibration routine initialization within a predetermined time period, performing stability analysis of the analyte sensor, and time shifting the calibration routine initialization to start at a time period different from the predetermined time period, processing the determined stability profile in conjunction with calibration criteria for the analyte sensor, and modifying a predetermined sensor calibration schedule based on the processed stability profile.

Embodiments also include a method comprising initializing an analyte sensor, activating a timer associated with the analyte sensor, the timer related to a stability profile of the analyte sensor, calibrating the analyte sensor based on a time corresponding reference data based at least in part on a predetermined calibration schedule including a plurality time periods for performing calibration over the life of the sensor, and modifying the calibration schedule to time shift the plurality of time periods for performing calibration.

A method in certain embodiments include detecting an input value associated with a reference data, verifying that an analyte sensor is within its calibration stability duration, calibrating the analyte sensor based on the detected input value, and time shifting the initiation of the one or more subsequent scheduled calibration events for the analyte sensor.

An apparatus in embodiments of the present disclosure includes one or more processors, and a memory for storing instructions which, when executed by the one or more processors, causes the one or more processors to determine a stability profile of an in vivo analyte sensor in fluid contact with a biological fluid by detecting the onset of a calibration routine initialization within a predetermined time period, performing stability analysis of the analyte sensor, and time shifting the calibration routine initialization to start at a time period different from the predetermined time period, to process the determined stability profile in conjunction with calibration criteria for the analyte sensor, and to modify a predetermined sensor calibration schedule based on the processed stability profile.

Embodiments also include an apparatus comprising one or more processors, and a memory for storing instructions which, when executed by the one or more processors, causes the one or more processors to initialize an analyte sensor, activate a timer associated with the analyte sensor, the timer related to a stability profile of the analyte sensor, calibrate the analyte sensor based on a time corresponding reference data based at least in part on a predetermined calibration schedule including a plurality time periods for performing calibration over the life of the sensor, and modify the calibration schedule to time shift the plurality of time periods for performing calibration.

Embodiments further include an apparatus comprising one or more processors, and a memory for storing instructions which, when executed by the one or more processors, causes the one or more processors to detect an input value associated with a reference data, verify that an analyte sensor is within its calibration stability duration, calibrate the analyte sensor based on the detected input value, and time shift the initiation of the one or more subsequent scheduled calibration events for the analyte sensor.

These and other features, objects and advantages of the invention will become apparent to those persons skilled in the art upon reading the details of the invention as more fully described below.

### INCORPORATION BY REFERENCE

The following patents, applications and/or publications are incorporated herein by reference for all purposes: U.S. Pat. Nos. 4,545,382; 4,711,245; 5,262,035; 5,262,305; 5,264,104; 5,320,715; 5,509,410; 5,543,326; 5,593,852; 5,601,435; 5,628,890; 5,820,551; 5,822,715; 5,899,855; 5,918,603; 6,071,391; 6,103,033; 6,120,676; 6,121,009; 6,134,461; 6,143,164; 6,144,837; 6,161,095; 6,175,752; 6,270,455; 6,284,478; 6,299,757; 6,338,790; 6,377,894; 6,461,496; 6,503,381; 6,514,460; 6,514,718; 6,540,891; 6,560,471; 6,579,690; 6,591,125; 6,592,745; 6,600,997; 6,605,200; 6,605,201; 6,616,819; 6,618,934; 6,650,471; 6,654,625; 6,676,816; 6,730,200; 6,736,957; 6,746,582; 6,749,740; 6,764,581; 6,773,671; 6,881,551; 6,893,545; 6,932,892; 6,932,894; 6,942,518; 7,167,818; and 7,299,082; U.S. Published Application Nos. 2004/0186365; 2005/0182306; 2007/0056858; 2007/0068807; 2007/0227911; 2007/0233013; 2008/0081977; 2008/0161666; and 2009/0054748; U.S. patent application Ser. Nos. 11/831,866; 11/831,881; 11/831,895; 12/102,839; 12/102,844; 12/102,847; 12/102,855; 12/102,856; 12/152,636; 12/152,648; 12/152,650; 12/152,652; 12/152,657; 12/152,662; 12/152,670; 12/152,673; 12/363,712; 12/131,012; 12/242,823; 12/363,712; 12/393,921; 12/495,709; 12/698,124; 12/699,653; 12/699,844; 12/714,439; 12/761,372; and 12/761,387 and U.S. Provisional Application Ser. Nos. 61/230,686 and 61/227,967.

### BRIEF DESCRIPTION OF THE DRAWINGS

A detailed description of various aspects, features and embodiments of the present disclosure is provided herein with reference to the accompanying drawings, which are briefly described below. The drawings are illustrative and are not necessarily drawn to scale, with some components and features being exaggerated for clarity. The drawings illustrate various aspects or features of the present disclosure and may illustrate one or more embodiment(s) or example(s) of the present disclosure in whole or in part. A reference numeral, letter, and/or symbol that is used in one drawing to refer to a particular element or feature maybe used in another drawing to refer to a like element or feature. Included in the drawings are the following:

FIG. 1 shows a block diagram of an embodiment of a data monitoring and management system with which a sensor according to the present disclosure is usable;

FIG. 2 shows a block diagram of an embodiment of the data processing unit of the data monitoring and management system of FIG. 1;

FIG. 3 shows a block diagram of an embodiment of the receiver/monitor unit of the data monitoring and management system of FIG. 1;

FIG. 4 shows a schematic diagram of an embodiment of an analyte sensor according to the present disclosure;

FIGS. 5A and 5B show perspective and cross sectional views, respectively, of an embodiment of an analyte sensor according to the present disclosure;

FIG. 6 is a flowchart illustrating dynamic sensor calibration scheduling routine based on sensor stability profile in accordance with one embodiment of the present disclosure; and

FIG. 7 is a flowchart illustrating another sensor calibration scheduling routine in accordance with another embodiment of the present disclosure.

### DETAILED DESCRIPTION

Before the various embodiments of the present disclosure are described, it is to be understood that the present disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

It must be noted that as used herein and in the appended claims, the singular forms “a”, “an”, and “the” include plural referents unless the context clearly dictates otherwise.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Generally, embodiments of the present disclosure relate to methods and devices for detecting at least one analyte, such as glucose, in body fluid. Embodiments relate to the continuous and/or automatic in vivo monitoring of the level of one or more analytes using a continuous analyte monitoring system that includes an analyte sensor for the in vivo detection, of an analyte, such as glucose, lactate, and the like, in a body fluid. Embodiments include wholly implantable analyte sensors and analyte sensors in which only a portion of the sensor is positioned under the skin and a portion of the sensor resides above the skin, e.g., for contact to a control unit, transmitter, receiver, transceiver, processor, etc. At least a portion of a sensor may be, for example, subcutaneously positionable in a patient for the continuous or semi-continuous monitoring of a level of an analyte in a patient's interstitial fluid. For the purposes of this description, semi-continuous monitoring and continuous monitoring will be used interchangeably, unless noted otherwise. The sensor response may be correlated and/or converted to analyte levels in blood or other fluids. In certain embodiments, an analyte sensor may be positioned in contact with interstitial fluid to detect the level of glucose, which detected glucose may be used to infer the glucose level in the patient's bloodstream. Analyte sensors may be insertable into a vein, artery, or other portion of the body containing fluid. Embodiments of the analyte sensors of the subject invention may be configured for monitoring the level of the analyte over a time period which may range from minutes, hours, days, weeks, or longer.

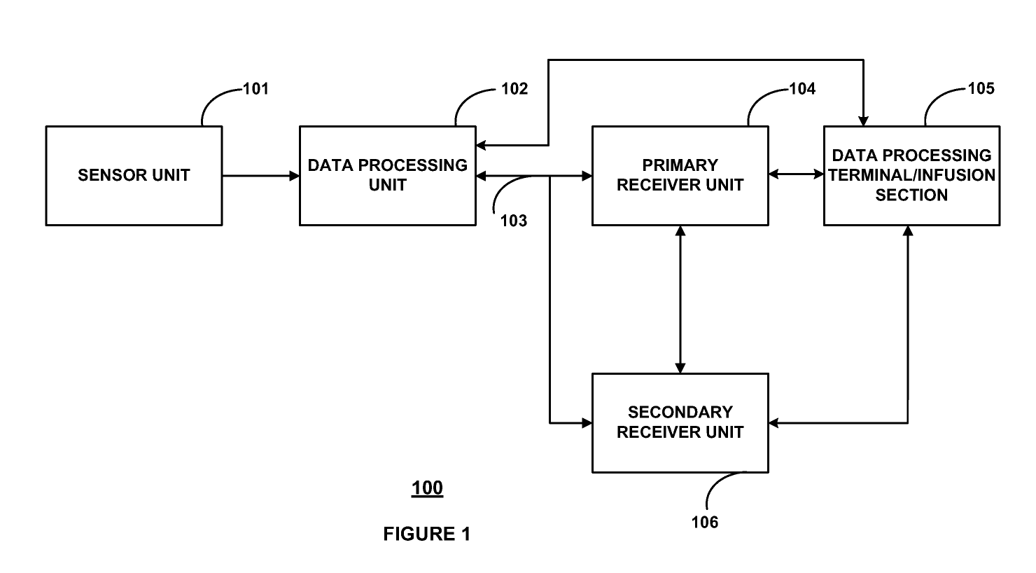

FIG. 1 shows a data monitoring and management system such as, for example, an analyte (e.g., glucose) monitoring system 100 in accordance with certain embodiments. Embodiments of the subject invention are further described primarily with respect to glucose monitoring devices and systems, and methods of glucose detection, for convenience only and such description is in no way intended to limit the scope of the invention. It is to be understood that the analyte monitoring system may be configured to monitor a variety of analytes instead of or in addition to glucose, e.g., at the same time or at different times.

Analytes that may be monitored include, but are not limited to, acetyl choline, amylase, bilirubin, cholesterol, chorionic gonadotropin, creatine kinase (e.g., CK-MB), creatine, creatinine, DNA, fructosamine, glucose, glutamine, growth hormones, hormones, ketone bodies, lactate, oxygen, peroxide, prostate-specific antigen, prothrombin, RNA, thyroid stimulating hormone, and troponin. The concentration of drugs, such as, for example, antibiotics (e.g., gentamicin, vancomycin, and the like), digitoxin, digoxin, drugs of abuse, theophylline, and warfarin, may also be monitored. In those embodiments that monitor more than one analyte, the analytes may be monitored at the same or different times.

The analyte monitoring system 100 includes a sensor 101, a data processing unit 102 connectable to the sensor 101, and a primary receiver unit 104 which is configured to communicate with the data processing unit 102 via a communication link 103. In certain embodiments, the primary receiver unit 104 may be further configured to transmit data to a data processing terminal 105 to evaluate or otherwise process or format data received by the primary receiver unit 104. The data processing terminal 105 may be configured to receive data directly from the data processing unit 102 via a communication link which may optionally be configured for bi-directional communication. Further, the data processing unit 102 may include a transmitter or a transceiver to transmit and/or receive data to and/or from the primary receiver unit 104 and/or the data processing terminal 105 and/or optionally the secondary receiver unit 106.

Also shown in FIG. 1 is an optional secondary receiver unit 106 which is operatively coupled to the communication link 103 and configured to receive data transmitted from the data processing unit 102. The secondary receiver unit 106 may be configured to communicate with the primary receiver unit 104, as well as the data processing terminal 105. The secondary receiver unit 106 may be configured for bi-directional wireless communication with each of the primary receiver unit 104 and the data processing terminal 105. As discussed in further detail below, in certain embodiments the secondary receiver unit 106 may be a de-featured receiver as compared to the primary receiver, i.e., the secondary receiver may include a limited or minimal number of functions and features as compared with the primary receiver unit 104. As such, the secondary receiver unit 106 may include a smaller (in one or more, including all, dimensions), compact housing or embodied in a device such as a wrist watch, arm band, etc., for example. Alternatively, the secondary receiver unit 106 may be configured with the same or substantially similar functions and features as the primary receiver unit 104. The secondary receiver unit 106 may include a docking portion to be mated with a docking cradle unit for placement by, e.g., the bedside for nighttime monitoring, and/or a bi-directional communication device. A docking cradle may recharge a power supply.

Only one sensor 101, data processing unit 102 and data processing terminal 105 are shown in the embodiment of the analyte monitoring system 100 illustrated in FIG. 1. However, it will be appreciated by one of ordinary skill in the art that the analyte monitoring system 100 may include more than one sensor 101 and/or more than one data processing unit 102, and/or more than one data processing terminal 105. Multiple sensors may be positioned in a patient for analyte monitoring at the same or different times. In certain embodiments, analyte information obtained by a first positioned sensor may be employed as a comparison to analyte information obtained by a second sensor. This may be useful to confirm or validate analyte information obtained from one or both of the sensors. Such redundancy may be useful if analyte information is contemplated in critical therapy-related decisions.

The analyte monitoring system 100 may be a continuous monitoring system or a semi-continuous monitoring system. In a multi-component environment, each component may be configured to be uniquely identified by one or more of the other components in the system so that communication conflict may be readily resolved between the various components within the analyte monitoring system 100. For example, unique identification codes (IDs), communication channels, and the like, may be used.

In certain embodiments, the sensor 101 is physically positioned in and/or on the body of a user whose analyte level is being monitored. The sensor 101 may be configured to continuously or semi-continuously sample the analyte level of the user automatically (without the user initiating the sampling), based on a programmed intervals such as, for example, but not limited to, once every minute, once every five minutes and so on, and convert the sampled analyte level into a corresponding signal for transmission by the data processing unit 102. The data processing unit 102 is coupleable to the sensor 101 so that both devices are positioned in or on the user's body, with at least a portion of the analyte sensor 101 positioned transcutaneously. The data processing unit 102 may include a fixation element such as adhesive or the like to secure it to the user's body. A mount (not shown) attachable to the user and mateable with the data processing unit 102 may be used. For example, a mount may include an adhesive surface. The data processing unit 102 performs data processing functions, where such functions may include but are not limited to, filtering and encoding of data signals, each of which corresponds to a sampled analyte level of the user, for transmission to the primary receiver unit 104 via the communication link 103. In one embodiment, the sensor 101 or the data processing unit 102 or a combined sensor/data processing unit may be wholly implantable under the skin layer of the user. Exemplary embodiments of the analyte monitoring system 100 of FIG. 1 can be found in, among others, U.S. patent application Ser. No. 12/698,124 incorporated herein by reference for all purposes.

In certain embodiments, the primary receiver unit 104 may include a signal interface section including an RF receiver and an antenna that is configured to communicate with the data processing unit 102 via the communication link 103, and a data processing section for processing the received data from the data processing unit 102 such as data decoding, error detection and correction, data clock generation, data bit recovery, etc., or any combination thereof.

In operation, the primary receiver unit 104 in certain embodiments is configured to synchronize with the data processing unit 102 to uniquely identify the data processing unit 102, based on, for example, an identification information of the data processing unit 102, and thereafter, to continuously or semi-continuously receive signals transmitted from the data processing unit 102 associated with the monitored analyte levels detected by the sensor 101. Referring again to FIG. 1, the data processing terminal 105 may include a personal computer, a portable computer such as a laptop or a handheld device (e.g., personal digital assistants (PDAs), telephone such as a cellular phone (e.g., a multimedia and Internet-enabled mobile phone such as an iPhone®, a BlackBerry® mobile device or similar mobile device), mp3 player, pager, a global positioning system (GPS) and the like), or drug delivery device, each of which may be configured for data communication with the receiver via a wired or a wireless connection. Additionally, the data processing terminal 105 may further be connected to a data network (not shown) for storing, retrieving, updating, and/or analyzing data corresponding to the detected analyte level of the user.

The data processing terminal 105 may include an infusion device such as an insulin infusion pump or the like, which may be configured to administer insulin to patients, and which may be configured to communicate with the primary receiver unit 104 for receiving, among others, the measured analyte level. Alternatively, the primary receiver unit 104 may be configured to integrate an infusion device therein so that the primary receiver unit 104 is configured to administer insulin (or other appropriate drug) therapy to patients, for example, for administering and modifying basal profiles, as well as for determining appropriate boluses for administration based on, among others, the detected analyte levels received from the data processing unit 102. An infusion device may be an external device or an internal device (wholly implantable in a user).

In certain embodiments, the data processing terminal 105, which may include an insulin pump, may be configured to receive the analyte signals from the data processing unit 102, and thus, incorporate the functions of the primary receiver unit 104 including data processing for managing the patient's insulin therapy and analyte monitoring. In certain embodiments, the communication link 103 as well as one or more of the other communication interfaces shown in FIG. 1, may use one or more of: an RF communication protocol, an infrared communication protocol, a Bluetooth® enabled communication protocol, an 802.11x wireless communication protocol, or an equivalent wireless communication protocol which would allow secure, wireless communication of several units (for example, per HIPPA requirements), while avoiding potential data collision and interference.

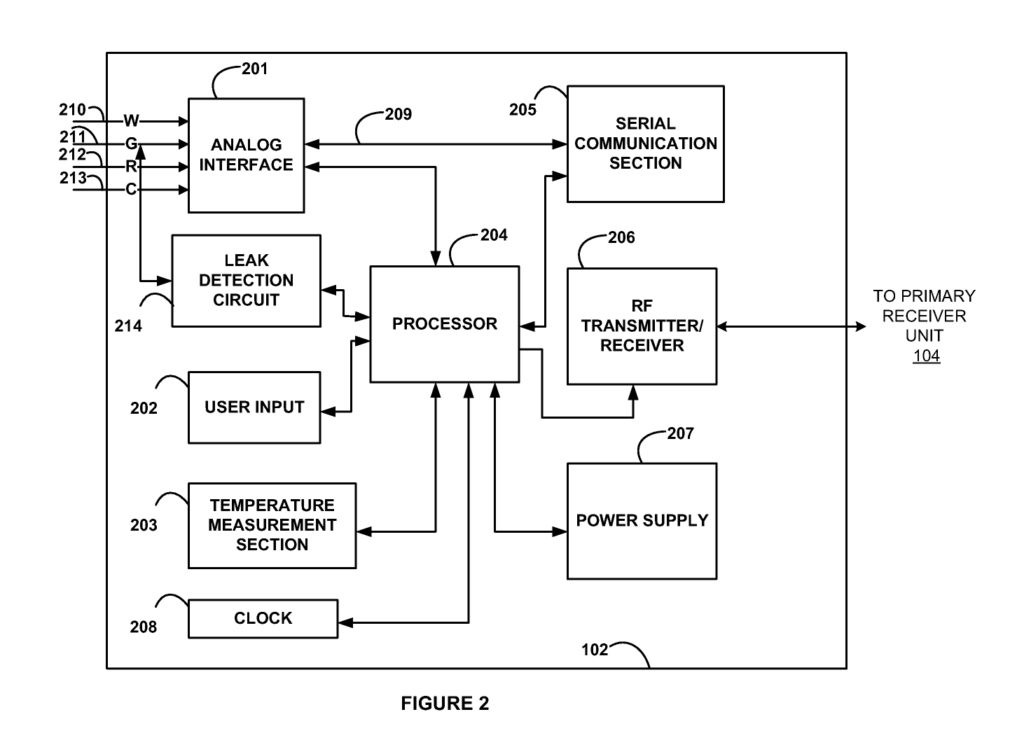

FIG. 2 shows a block diagram of an embodiment of a data processing unit of the data monitoring and detection system shown in FIG. 1. The data processing unit 102 thus may include one or more of an analog interface 201 configured to communicate with the sensor 101 (FIG. 1), a user input 202, and a temperature measurement section 203, each of which is operatively coupled to a processor 204 such as a central processing unit (CPU). User input and/or interface components may be included or a data processing unit may be free of user input and/or interface components. In certain embodiments, one or more application-specific integrated circuits (ASICs) may be used to implement one or more functions or routines associated with the operations of the data processing unit (and/or receiver unit) using for example one or more state machines and buffers.

Further shown in FIG. 2 are a transmitter serial communication section 205 and an RF transmitter 206, each of which is also operatively coupled to the processor 204. The RF transmitter 206, in some embodiments, may be configured as an RF receiver or an RF transmitter/receiver, such as a transceiver, to transmit and/or receive data signals. Moreover, a power supply 207, such as a battery, may also be provided in the data processing unit 102 to provide the necessary power for the data processing unit 102. Additionally, as can be seen from the Figure, clock 208 may be provided to, among others, supply real time information to the processor 204.

As can be seen in the embodiment of FIG. 2, the sensor 101 (FIG. 1) includes four contacts, three of which are electrodes—work electrode (W) 210, guard contact (G) 211, reference electrode (R) 212, and counter electrode (C) 213, each operatively coupled to the analog interface 201 of the data processing unit 102. In certain embodiments, each of the work electrode (W) 210, guard contact (G) 211, reference electrode (R) 212, and counter electrode (C) 213 may be made using a conductive material that may be applied by, e.g., chemical vapor deposition (CVD), physical vapor deposition, sputtering, reactive sputtering, printing, coating, ablating (e.g., laser ablation), painting, dip coating, etching, and the like.

In certain embodiments, a unidirectional input path is established from the sensor 101 (FIG. 1) and/or manufacturing and testing equipment to the analog interface 201 of the data processing unit 102, while a unidirectional output is established from the output of the RF transmitter 206 of the data processing unit 102 for transmission to the primary receiver unit 104. In this manner, a data path is shown in FIG. 2 between the aforementioned unidirectional input and output via a dedicated link 209 from the analog interface 201 to serial communication section 205, thereafter to the processor 204, and then to the RF transmitter 206. As such, in certain embodiments, via the data path described above, the data processing unit 102 is configured to transmit to the primary receiver unit 104 (FIG. 1), via the communication link 103 (FIG. 1), processed and encoded data signals received from the sensor 101 (FIG. 1). Additionally, the unidirectional communication data path between the analog interface 201 and the RF transmitter 206 discussed above allows for the configuration of the data processing unit 102 for operation upon completion of the manufacturing process as well as for direct communication for diagnostic and testing purposes.

The processor 204 may be configured to transmit control signals to the various sections of the data processing unit 102 during the operation of the data processing unit 102. In certain embodiments, the processor 204 also includes memory (not shown) for storing data such as the identification information for the data processing unit 102, as well as the data signals received from the sensor 101. The stored information may be retrieved and processed for transmission to the primary receiver unit 104 under the control of the processor 204. Furthermore, the power supply 207 may include a commercially available battery.

The data processing unit 102 is also configured such that the power supply section 207 is capable of providing power to the data processing unit 102 for a minimum period of time, e.g., at least about one month, e.g., at least about three months or more, of continuous operation. The minimum may be after (i.e., in addition to), a period of time, e.g., up to about eighteen months, of being stored in a low- or no-power (non-operating) mode. In certain embodiments, this may be achieved by the processor 204 operating in low power modes in the non-operating state, for example, drawing no more than minimal current, e.g., approximately 1 μA of current or less. In certain embodiments, a manufacturing process of the data processing unit 102 may place the data processing unit 102 in the lower power, non-operating state (i.e., post-manufacture sleep mode). In this manner, the shelf life of the data processing unit 102 may be significantly improved. Moreover, as shown in FIG. 2, while the power supply unit 207 is shown as coupled to the processor 204, and as such, the processor 204 is configured to provide control of the power supply unit 207, it should be noted that within the scope of the present disclosure, the power supply unit 207 is configured to provide the necessary power to each of the components of the data processing unit 102 shown in FIG. 2.

Referring back to FIG. 2, the power supply section 207 of the data processing unit 102 in one embodiment may include a rechargeable battery unit that may be recharged by a separate power supply recharging unit (for example, provided in the receiver unit 104) so that the data processing unit 102 may be powered for a longer period of usage time. In certain embodiments, the data processing unit 102 may be configured without a battery in the power supply section 207, in which case the data processing unit 102 may be configured to receive power from an external power supply source (for example, a battery, electrical outlet, etc.) as discussed in further detail below.

Referring yet again to FIG. 2, a temperature measurement section 203 of the data processing unit 102 is configured to monitor the temperature of the skin near the sensor insertion site. The temperature reading may be used to adjust the analyte readings obtained from the analog interface 201.

The RF transmitter 206 of the data processing unit 102 may be configured for operation in a certain frequency band, e.g., the frequency band of 315 MHz to 322 MHz (or other suitable ranges), for example, in the United States. (The frequency band may be the same or different outside the United States. Further, in certain embodiments, the RF transmitter 206 is configured to modulate the carrier frequency by performing, e.g., Frequency Shift Keying and Manchester encoding, and/or other protocol(s). In certain embodiments, the data transmission rate is set for efficient and effective transmission. For example, in certain embodiments the data transmission rate may be about 19,200 symbols per second, with a minimum transmission range for communication with the primary receiver unit 104.

Also shown is a leak detection circuit 214 coupled to the guard electrode (G) 211 and the processor 204 in the data processing unit 102 of the data monitoring and management system 100. The leak detection circuit 214 may be configured to detect leakage current in the sensor 101 to determine whether the measured sensor data are corrupt or whether the measured data from the sensor 101 is accurate. Such detection may trigger a notification to the user.

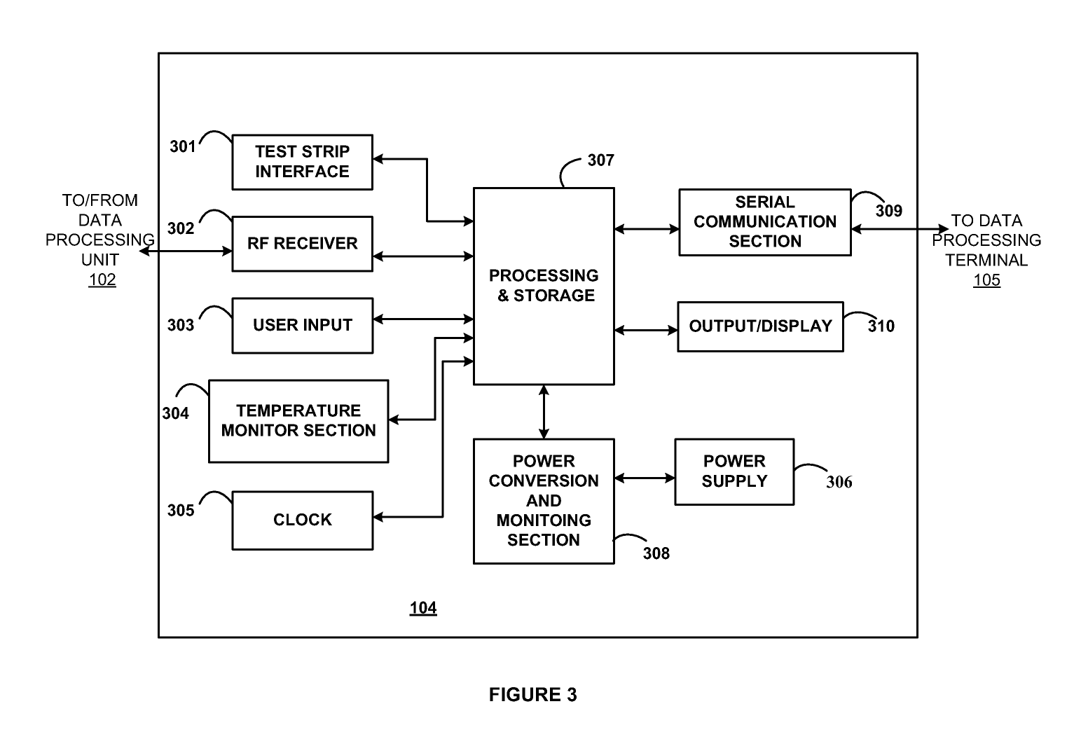

FIG. 3 shows a block diagram of an embodiment of a receiver/monitor unit such as the primary receiver unit 104 of the data monitoring and management system shown in FIG. 1. The primary receiver unit 104 may include one or more of: a blood glucose test strip interface 301 for in vitro testing, an RF receiver 302, an input 303, a temperature monitor section 304, and a clock 305, each of which is operatively coupled to a processing and storage section 307. The primary receiver unit 104 also includes a power supply 306 operatively coupled to a power conversion and monitoring section 308. Further, the power conversion and monitoring section 308 is also coupled to the receiver processor 307. Moreover, also shown are a receiver serial communication section 309, and an output 310, each operatively coupled to the processing and storage unit 307. The receiver may include user input and/or interface components or may be free of user input and/or interface components.

In certain embodiments having a test strip interface 301, the interface includes a glucose level testing portion to receive a blood (or other body fluid sample) glucose test or information related thereto. For example, the interface may include a test strip port to receive a glucose test strip. The device may determine the glucose level of the test strip, and optionally display (or otherwise notice) the glucose level on the output 310 of the primary receiver unit 104. Any suitable test strip may be employed, e.g., test strips that only require a very small amount (e.g., one microliter or less, e.g., 0.5 microliter or less, e.g., 0.1 microliter or less), of applied sample to the strip in order to obtain accurate glucose information, e.g. FreeStyle® and Precision® blood glucose test strips from Abbott Diabetes Care Inc.

Glucose information obtained by the in vitro glucose testing device may be used for a variety of purposes, computations, etc. For example, the information may be used to calibrate sensor 101 (however, calibration of the subject sensors may not be necessary), confirm results of the sensor 101 to increase the confidence thereof (e.g., in instances in which information obtained by sensor 101 is employed in therapy related decisions), etc. Exemplary blood glucose monitoring systems are described, e.g., in U.S. Pat. Nos. 6,071,391; 6,120,676; 6,338,790; and 6,616,819; and in U.S. application Ser. Nos. 11/282,001; and 11/225,659, the disclosures of which are herein incorporated by reference. Glucose monitoring systems that allow for sample extraction from sites other than the finger and/or that can operate using small samples of blood, have been developed. (See, e.g., U.S. Pat. Nos. 6,120,676, 6,591,125, and 7,299,082, the disclosures of which are herein incorporated by reference). Typically, about one μL or less of sample may be required for the proper operation of these devices, which enables glucose testing with a sample of blood obtained from the surface of a palm, a hand, an arm, a thigh, a leg, the torso, or the abdomen. Even though less painful than the finger stick approach, these other sample extraction methods are still inconvenient and may also be somewhat painful.

The RF receiver 302 is configured to communicate, via the communication link 103 (FIG. 1) with the RF transmitter 206 of the data processing unit 102, to receive encoded data signals from the data processing unit 102 for, among others, signal mixing, demodulation, and other data processing. The input 303 of the primary receiver unit 104 is configured to allow the user to enter information into the primary receiver unit 104 as needed. In one aspect, the input 303 may include keys of a keypad, a touch-sensitive screen, and/or a voice-activated input command unit, and the like. The temperature monitor section 304 is configured to provide temperature information of the primary receiver unit 104 to the receiver processing and storage unit 307, while the clock 305 provides, among others, real time information to the receiver processing and storage unit 307.

Each of the various components of the primary receiver unit 104 shown in FIG. 3 is powered by the power supply 306 (and/or other power supply) which, in certain embodiments, includes a battery. Furthermore, the power conversion and monitoring section 308 is configured to monitor the power usage by the various components in the primary receiver unit 104 for effective power management and may alert the user, for example, in the event of power usage which renders the primary receiver unit 104 in sub-optimal operating conditions. An example of such sub-optimal operating condition may include, for example, operating the vibration output mode (as discussed below) for a period of time thus substantially draining the power supply 306 while the processing and storage unit 307 (thus, the primary receiver unit 104) is turned on. Moreover, the power conversion and monitoring section 308 may additionally be configured to include a reverse polarity protection circuit such as a field effect transistor (FET) configured as a battery activated switch.

The serial communication section 309 in the primary receiver unit 104 is configured to provide a bi-directional communication path from the testing and/or manufacturing equipment for, among others, initialization, testing, and configuration of the primary receiver unit 104. Serial communication section 309 can also be used to upload data to a computer, such as time-stamped blood glucose data. The communication link with an external device (not shown) can be made, for example, by cable, infrared (IR) or RF link. The output 310 of the primary receiver unit 104 is configured to provide, among others, a graphical user interface (GUI) such as a liquid crystal display (LCD) for displaying information. Additionally, the output 310 may also include an integrated speaker for outputting audible signals as well as to provide vibration output as commonly found in handheld electronic devices, such as mobile telephones, pagers, etc. In certain embodiments, the primary receiver unit 104 also includes an electro-luminescent lamp configured to provide backlighting to the output 310 for output visual display in dark ambient surroundings.

Referring back to FIG. 3, the primary receiver unit 104 may also include a storage section such as a programmable, non-volatile memory device as part of the processing and storage unit 307, or provided separately in the primary receiver unit 104, operatively coupled to the processor. The processing and storage unit 307 may be configured to perform Manchester decoding (or other protocol(s)) as well as error detection and correction upon the encoded data signals received from the data processing unit 102 via the communication link 103 (FIG. 1).

In further embodiments, the data processing unit 102 and/or the primary receiver unit 104 and/or the secondary receiver unit 106 (FIG. 1), and/or the data processing terminal/infusion section 105 may be configured to receive the blood glucose value from a wired connection or wirelessly over a communication link from, for example, a blood glucose meter. In further embodiments, a user manipulating or using the analyte monitoring system 100 (FIG. 1) may manually input the blood glucose value using, for example, a user interface (for example, a keyboard, keypad, voice commands, and the like) incorporated in the one or more of the data processing unit 102, the primary receiver unit 104, secondary receiver unit 106, or the data processing terminal/infusion section 105.

In certain embodiments, the data processing unit 102 (FIG. 1) is configured to detect the current signal from the sensor 101 (FIG. 1) and optionally the skin and/or ambient temperature near the sensor 101, which may be preprocessed by, for example, the data processing unit processor 204 (FIG. 2) and transmitted to the receiver unit (for example, the primary receiver unit 104 (FIG. 1)) at least at a predetermined time interval, such as for example, but not limited to, once per minute, once every two minutes, once every five minutes, or once every ten minutes. Additionally, the data processing unit 102 may be configured to perform sensor insertion detection and data quality analysis, information pertaining to which may also transmitted to the receiver unit 104 periodically at the predetermined time interval. In turn, the receiver unit 104 may be configured to perform, for example, skin temperature compensation as well as calibration of the sensor data received from the data processing unit 102.

Additional detailed descriptions are provided in U.S. Pat. Nos. 5,262,035; 5,264,104; 5,262,305; 5,320,715; 5,593,852; 6,103,033; 6,134,461; 6,175,752; 6,560,471; 6,579,690; 6,605,200; 6,654,625; 6,746,582; and 6,932,894; and in U.S. Published Patent Application Nos. 2004/0186365, the disclosures of which are herein incorporated by reference.

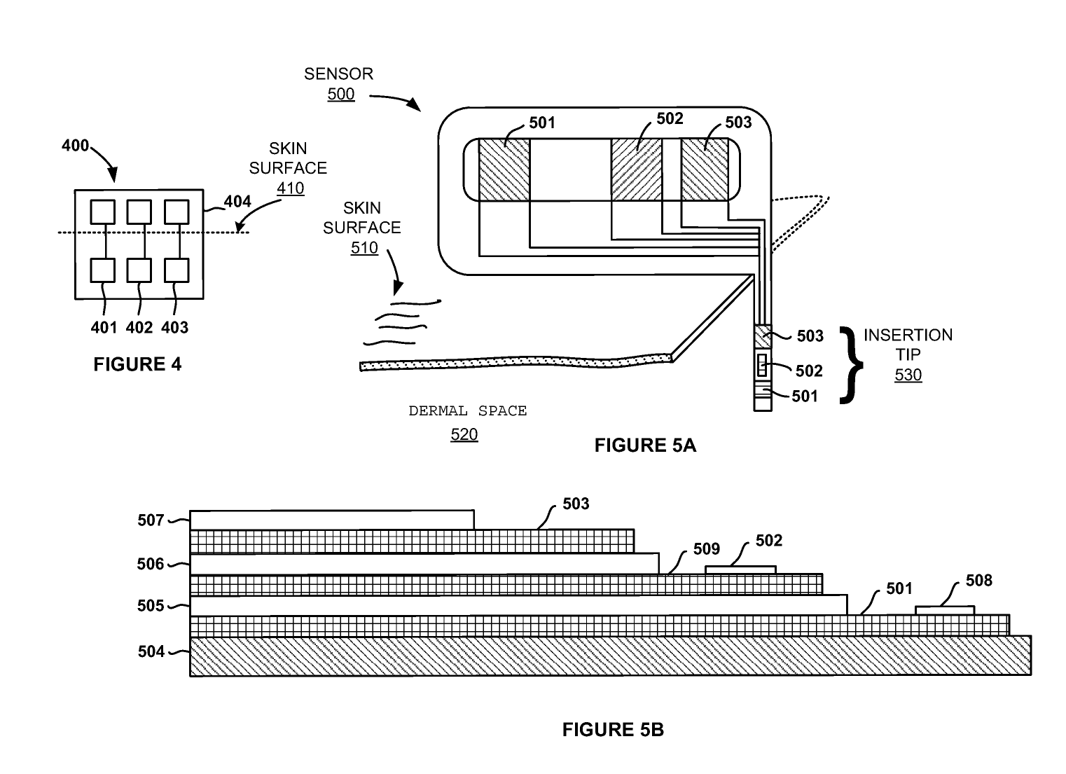

FIG. 4 schematically shows an embodiment of an analyte sensor usable in the analyte monitoring systems described herein. Sensor embodiments include electrodes 401, 402 and 403 on a base 404. Electrodes (and/or other features) may be applied or otherwise processed using any suitable technology, e.g., chemical vapor deposition (CVD), physical vapor deposition, sputtering, reactive sputtering, printing, coating, ablating (e.g., laser ablation), painting, dip coating, etching and the like. Suitable conductive materials include but are not limited to aluminum, carbon (such as graphite), cobalt, copper, gallium, gold, indium, iridium, iron, lead, magnesium, mercury (as an amalgam), nickel, niobium, osmium, palladium, platinum, rhenium, rhodium, selenium, silicon (e.g., doped polycrystalline silicon), silver, tantalum, tin, titanium, tungsten, uranium, vanadium, zinc, zirconium, mixtures thereof, and alloys, oxides, or metallic compounds of these elements.

The sensor may be wholly implantable in a user or may be configured so that only a portion is positioned within (internal) a user and another portion outside (external) a user. For example, the sensor 400 may include a portion positionable above a surface of the skin 410, and a portion positioned below the skin. In such embodiments, the external portion may include contacts (connected to respective electrodes of the second portion by traces) to connect to another device also external to the user such as a transmitter unit. While the embodiment of FIG. 4 shows three electrodes side-by-side on the same surface of base 404, other configurations are contemplated, e.g., fewer or greater electrodes, some or all electrodes on different surfaces of the base or present on another base, some or all electrodes stacked together, some or all electrodes twisted together (e.g., an electrode twisted around or about another or electrodes twisted together), electrodes of differing materials and dimensions, etc.

In other embodiments, the sensor is a self-powered sensor, such as the sensor described in U.S. patent application Ser. No. 12/393,921, incorporated herein by reference.

FIG. 5A shows a perspective view of an embodiment of an electrochemical analyte sensor 500 of the present disclosure having a first portion (which in this embodiment may be characterized as a major or body portion) positionable above a surface of the skin 510, and a second portion (which in this embodiment may be characterized as a minor or tail portion) that includes an insertion tip 530 positionable below the skin, e.g., penetrating through the skin and into, e.g., the subcutaneous space 520, in contact with the user's biofluid such as interstitial fluid. Contact portions of a working electrode 501, a reference electrode 502, and a counter electrode 503 are positioned on the portion of the sensor 500 situated above the skin surface 510. Working electrode 501, a reference electrode 502, and a counter electrode 503 are shown at the second section and particularly at the insertion tip 530. Traces may be provided from the electrode at the tip to the contact, as shown in FIG. 5A. It is to be understood that greater or fewer electrodes may be provided on a sensor. For example, a sensor may include more than one working electrode and/or the counter and reference electrodes may be a single counter/reference electrode, etc.

FIG. 5B shows a cross sectional view of a portion of the sensor 500 of FIG. 5A. The electrodes 501, 502 and 503 of the sensor 500 as well as the substrate and the dielectric layers are provided in a layered configuration or construction. For example, as shown in FIG. 5B, in one aspect, the sensor 500 (such as the sensor 101 FIG. 1), includes a substrate layer 504, and a first conducting layer 501 such as carbon, gold, etc., disposed on at least a portion of the substrate layer 504, and which may provide the working electrode. Also shown disposed on at least a portion of the first conducting layer 501 is a sensing component or layer 508, discussed in greater detail below. The area of the conducting layer covered by the sensing layer is herein referred to as the active area. A first insulation layer such as a first dielectric layer 505 is disposed or layered on at least a portion of the first conducting layer 501, and further, a second conducting layer 502 may be disposed or stacked on top of at least a portion of the first insulation layer (or dielectric layer) 505, and which may provide the reference electrode.

In one aspect, conducting layer 502 may include a layer of silver/silver chloride (Ag/AgCl), gold, etc. A second insulation layer 506 such as a dielectric layer in one embodiment may be disposed or layered on at least a portion of the second conducting layer 509. Further, a third conducting layer 503 may provide the counter electrode 503. It may be disposed on at least a portion of the second insulation layer 506. Finally, a third insulation layer 507 may be disposed or layered on at least a portion of the third conducting layer 503. In this manner, the sensor 500 may be layered such that at least a portion of each of the conducting layers is separated by a respective insulation layer (for example, a dielectric layer). The embodiment of FIGS. 5A and 5B show the layers having different lengths. Some or all of the layers may have the same or different lengths and/or widths.

In addition to the electrodes, sensing layer and dielectric layers, sensor 500 may also include a temperature probe, a mass transport limiting layer, a biocompatible layer, and/or other optional components (none of which are illustrated). Each of these components enhances the functioning of and/or results from the sensor.

Substrate 504 may be formed using a variety of non-conducting materials, including, for example, polymeric or plastic materials and ceramic materials. (It is to be understood that substrate includes any dielectric material of a sensor, e.g., around and/or in between electrodes of a sensor such as a sensor in the form of a wire wherein the electrodes of the sensor are wires that are spaced-apart by a substrate).

Although the sensor substrate, in at least some embodiments, has uniform dimensions along the entire length of the sensor, in other embodiments, the substrate has a distal end or tail portion and a proximal end or body portion with different widths, respectively, as illustrated in FIG. 5A. In these embodiments, the distal end 530 of the sensor may have a relatively narrow width. For in vivo sensors which are implantable into the subcutaneous tissue or another portion of a patient's body, the narrow width of the distal end of the substrate may facilitate the implantation of the sensor. Often, the narrower the width of the sensor, the less pain the patient will feel during implantation of the sensor and afterwards.

For subcutaneously implantable sensors which are designed for continuous or semi-continuous monitoring of the analyte during normal activities of the patient, a tail portion or distal end of the sensor which is to be implanted into the patient may have a width of about 2 mm or less, e.g., about 1 mm or less, e.g., about 0.5 mm or less, e.g., about 0.25 mm or less, e.g., about 0.15 or less. However, wider or narrower sensors may be used. The proximal end of the sensor may have a width larger than the distal end to facilitate the connection between the electrode contacts and contacts on a control unit, or the width may be substantially the same as the distal portion.

Electrodes 501, 502 and 503 are formed using conductive traces disposed on the substrate 504. These conductive traces may be formed over a smooth surface of the substrate or within channels formed by, for example, embossing, indenting or otherwise creating a depression in the substrate. The conductive traces may extend most of the distance along a length of the sensor, as illustrated in FIG. 5A, although this is not necessary. For implantable sensors, particularly subcutaneously implantable sensors, the conductive traces typically may extend close to the tip of the sensor to minimize the amount of the sensor that must be implanted.

The conductive traces may be formed on the substrate by a variety of techniques, including, for example, photolithography, screen printing, or other impact or non-impact printing techniques. The conductive traces may also be formed by carbonizing conductive traces in an organic (e.g., polymeric or plastic) substrate using a laser. A description of some exemplary methods for forming the sensor is provided in U.S. patents and applications noted herein, including U.S. Pat. Nos. 5,262,035, 6,103,033, 6,175,752; and 6,284,478, the disclosures of which are herein incorporated by reference.

Certain embodiments include a Wired Enzyme™ sensing layer (such as used in the FreeStyle Navigator® continuous glucose monitoring system by Abbott Diabetes Care Inc.) that works at a gentle oxidizing potential, e.g., a potential of about +40 mV. This sensing layer uses an osmium (Os)-based mediator designed for low potential operation and is stably anchored in a polymeric layer. Accordingly, in certain embodiments the sensing element is redox active component that includes (1) Osmium-based mediator molecules attached by stable (bidente) ligands anchored to a polymeric backbone, and (2) glucose oxidase enzyme molecules. These two constituents are crosslinked together.

Examples of sensing layers that may be employed are described in U.S. patents and applications noted herein, including, e.g., in U.S. Pat. Nos. 5,262,035, 5,264,104, 5,543,326, 6,605,200, 6,605,201, 6,676,819, and 7,299,082, the disclosures of which are herein incorporated by reference.

Regardless of the particular components that make up a given sensing layer, a variety of different sensing layer configurations may be used. In certain embodiments, the sensing layer covers the entire working electrode surface, e.g., the entire width of the working electrode surface. In other embodiments, only a portion of the working electrode surface is covered by the sensing layer, e.g., only a portion of the width of the working electrode surface. Alternatively, the sensing layer may extend beyond the conductive material of the working electrode. In some cases, the sensing layer may also extend over other electrodes, e.g., over the counter electrode and/or reference electrode (or counter/reference is provided), and may cover all or only a portion thereof.

Calibration, when an electrochemical glucose sensor is used, generally involves converting the raw current signal (nA) into a glucose concentration (mg/dL). One way in which this conversion is achieved is by relating or equating the raw analyte signal with a calibration measurement (i.e., with a reference measurement), and obtaining a conversion factor (raw analyte signal/reference measurement value). This relationship is often referred to as the sensitivity of the sensor, which, once determined, may then be used to convert sensor signals to calibrated analyte concentration values, e.g., via simple division (raw analyte signal/sensitivity=calibrated analyte concentration). For example, a raw analyte signal of 10 nA could be associated with a calibration analyte concentration of 100 mg/dL, and thus, a subsequent raw analyte signal of 20 nA could be converted to an analyte concentration of 200 mg/dL, as may be appropriate for a given analyte, such as glucose, for example.

There are many ways in which the conversion factor may be obtained. For example, the sensitivity factor can be derived from a simple average of multiple analyte signal/calibration measurement data pairs, or from a weighted average of multiple analyte signal/calibration measurement data pairs. Further by way of example, the sensitivity may be modified based on an empirically derived weighting factor, or the sensitivity may be modified based on the value of another measurement, such as temperature. It will be appreciated that any combination of such approaches, and/or other suitable approaches, is contemplated herein.

Exemplary calibration protocols, routines and techniques are described, for example, in U.S. Pat. No. 7,299,082, U.S. patent application Ser. No. 11/537,991 filed Oct. 2, 2006, and in U.S. patent application Ser. No. 12/363,712 filed Jan. 30, 2009, the disclosure of each of which are herein incorporated by reference for all purposes.

In one embodiment, the calibration information or routine is programmed or is programmable into software of the monitoring system, e.g., into one or more processors. For example, calibration of sensor signal may be implemented using suitable hardware/software of the system.

In one aspect of the present disclosure, a dynamic sensor calibration schedule for analyte monitoring system is provided. More specifically, in one aspect, based on the stability profile of the sensor, the baseline or predetermined calibration time periods may be dynamically modified, providing convenience and improved functionality to the user of the analyte monitoring system.

More specifically, in accordance with aspects of the present disclosure, self initiated in vitro blood glucose tests performed (whether to confirm the in vivo sensor accuracy, for example, in response to a calibration prompt provided by the system, or whether performed independent of a scheduled calibration event by the user to, for example, determine a correction insulin bolus dose) may be used to calibrate the in vivo analyte sensor in conjunction with an analysis of the sensor profile, such as, for example, the stability profile of the analyte sensor.

That is, in one aspect, a calibration stability duration or a “stability profile” may be predetermined or assigned to the analyte sensor during the various time periods of the sensor usage/life. For example, in one aspect, after initialization of the sensor at the beginning of its usage, the first 12 hours of the sensor usage (measured for example, from the sensor positioning/insertion time) may be associated with a two hour window of sensor calibration stability duration. Thereafter, the next 12 hours (or, the time period spanning 12 to 24 hours measured from the initial sensor insertion/initialization or positioning) may be associated with a calibration stability duration of 6 hours, during which it is determined that the analyte sensor property is deemed to be stable (for example, for purposes of performing sensor calibration). Returning to the example above, the subsequent 48 hour period measured from the initial sensor insertion (that is, the 24 hour to 72 hour time period from the sensor insertion) may be associated with a calibration stability duration of a 12 hour period (during which, the sensor is considered to be sufficiently stable for performing calibration), and thereafter, the following 48 hour period (that is, the time period from the 72 hour to 120 hours measured from the initial sensor insertion/positioning and initialization for use) is associated in one embodiment, with a calibration stability duration of a 24 hour time window, during which, the sensor is considered to be sufficiently stable for performing calibration routine.

In another embodiment, the first 6 hours of sensor usage may be associated with a two hour window of sensor calibration stability duration, the next 18 hours of sensor life associated with a calibration stability duration of 8 hours, and so on. In still a further embodiment, the calibration stability duration for each 12 hour period is increased linearly, so that the first 12 hours of sensor life is associated with a 2 hour calibration stability duration, the next 12 hours of sensor life associated with a 4 hour calibration stability duration, the following 12 hours of sensor life associated with a 6 hour calibration stability duration and so on. Other calibration stability durations are also contemplated within the scope of the present disclosure including those which increments the stability duration in a nonlinear fashion and so on.

In this manner, in one aspect, the analyte monitoring system (for example, the receiver unit of the monitoring system) may be configured to monitor the time period of each sensor calibration event, for example, determined from the initial sensor insertion/positioning and initialization for use, and when it is determined that the system has not received a current in vitro blood glucose measurement for calibration during the calibration stability duration associated with the one or more time periods of sensor wear, the system may be configured to prompt the user or the patient to perform a blood glucose test to execute or initiate the in vivo sensor calibration routine. Detailed description of signal processing related to sensor initialization, signal filtering, and processing can be found in U.S. Pat. Nos. 6,175,752, 6,560,471, and in U.S. patent application Ser. No. 12/152,649 filed May 14, 2008, disclosure of each of which are incorporated herein by reference for all purposes.

Upon successfully completing the executed calibration routine, in one aspect, the monitoring system may be configured to reset or modify the next or subsequent scheduled calibration event based on the successful calibration routine performed, rather than maintaining the baseline or pre-programmed calibration schedule for calibrating the sensor. Moreover, when the user or the patient performs an in vitro blood glucose test and inputs the glucose information to the monitoring system (for example, the receiver unit) to perform sensor calibration even though the calibration request based on the predetermined calibration schedule has not yet been triggered, the results from the performed blood glucose test in one embodiment may be used to perform sensor calibration, and thereafter, extending the calibration stability duration or profile in view of the self or manually initiated blood glucose measurement provided to the monitoring system.

In one aspect, a timer or clock may be provided on the user interface (or display) of the receiver unit to provide a visual, tactile, or audible indication of the subsequent or upcoming scheduled calibration and the associated calibration stability duration. Such indication may include one or more of an icon, a graphical representation, a video graphics, a two-dimensional representation, an alphanumeric display, a sound, a predetermined vibration of the device (for example, the receiver unit), or one or more combinations thereof. With the ability to view the upcoming scheduled calibration time period and the corresponding calibration stability duration, in one aspect, the user of the monitoring system may dynamically modify the predetermined calibration schedule to tailor the calibration events to be more convenient to the user.

For example, prior to going to bed at night, the user may review the calibration stability duration information provided on the receiver unit of the monitoring system, for example, that the user is in the 12 hour time period for calibration stability duration, of which, 8 hours have already elapsed. In such a case, in one aspect, the receiver unit of the monitoring system, for example, may generate and output a calibration prompt or alarm after 4 hours have elapsed (that is, since 8 hours has elapsed, and the user is preparing to go to bed), the pre-programmed alarm or notification associated with the calibration is programmed to be output 4 hours after the user goes to bed. With this information, since it is inconvenient to wake up or get up after 4 hours of sleeping to perform an in vitro blood glucose test for in vivo sensor calibration, the user may self initiate the in vitro blood glucose test prior to going to bed and perform sensor calibration using the data from the blood glucose test.

Then, the associated calibration stability duration may be extended to a 12 hour time period from when the in vitro blood glucose test was performed (or when the user is going to sleep). In this case, in one aspect, the user will likely not be inconvenienced when attempting to maintain the calibration schedule of the analyte sensor, and further, maintaining the integrity of the analyte monitoring system so as to ensure that the sensor is properly calibrated to provide accurate, real time information associated with the monitored analyte levels.

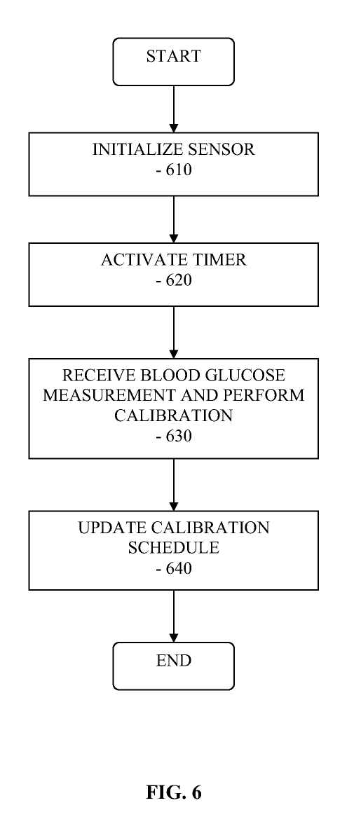

Referring now to the Figures, FIG. 6 is a flowchart illustrating dynamic sensor calibration based on sensor stability profile in accordance with one embodiment of the present disclosure. Referring to FIG. 6, when the analyte sensor is transcutaneously positioned such that at least a portion is in fluid contact with the analyte (for example, interstitial fluid) of a subject, an initialization routine is executed (by, for example, one or more transmitter unit/data processing unit 102 (FIG. 1) or the receiver unit 104 (FIG. 1) (610). Also, a clock or a timing device is activated to maintain timing information of the sensor usage from initialization in the analyte monitoring system (620).

In one aspect, the clock or timing device may be triggered or started with the initialization of the sensor, and each sensor signal or data (corresponding to the monitored analyte level) is associated with corresponding time information based on the time data from the clock or timing device. In the case where the clock or timing device is in the data processing unit 102 (FIG. 1), in one embodiment, the data packet from the transmitter unit may be configured to including the timing information (such as a time and/or date stamp) associated with each processed sensor data for transmission to the receiver unit 104 (FIG. 1). In another embodiment, the clock or timing device may be maintained in the receiver unit 104 (FIG. 1), such that when the sensor data is received from the data processing unit 102 (FIG. 1), the receiver unit 104 may be configured to generate and associate timing information for each received sensor data for further processing, storage and transmission to one or more remote locations (such as over a data network, or using a local connection to a host or personal computer with software suitable for processing and analyzing glucose information for the patient or the subject). In still a further aspect, the clock or timing device may be maintained or functional in both the data processing unit and the receiver unit, and, may be used to time synchronize the two components, in addition to maintaining timing information associated with the sensor data.

As discussed above, each time period or segment of the sensor usage may be associated with a corresponding predetermined calibration stability duration. For example, the first 12 hours of the sensor usage measured from the sensor initialization may be associated with a two hour calibration stability duration or window. Accordingly, depending upon the clock or timing device information, the corresponding calibration stability duration is retrieved (for example, from storage device such a memory device). The analyte monitoring system generates and outputs a calibration prompt to the user to perform sensor calibration when the calibration stability duration expiration is approaching (for example, within 30 minutes of the two hour duration expiration), and further, the analyte monitoring system monitors for any data input associated with in vitro blood glucose measurements independent of calibration requests that are received, for example, within the calibration stability duration.

In one aspect, an output indicator associated with the calibration stability duration may be generated and output to the user. For example, the display on the receiver unit 104 (FIG. 1) may be configured to illustrate an icon, a graphical indicator or a numerical indicator, or one or more combinations, which indicate the time period remaining for the particular calibration stability duration that is retrieved and associated with the sensor usage period. Such indicator would assist the user to modify user behavior knowing that a calibration prompt or request from the monitoring system is approaching, especially when the user will not have ready access to the calibration tool, such as in vitro blood glucose meter device to determine the reference blood glucose measurement so that the in vivo sensor calibration may be performed.

Furthermore, in the case where the user is planning to go to sleep within a couple of hours, and the user is aware that the monitoring system calibration request is approaching in approximately 4 hours (which may be in the middle of the night when the user will likely be asleep), the user decides to perform the sensor calibration prior to going to sleep, so that the next schedule calibration for the analyte sensor may be rescheduled to a time beyond the initially approaching time period of 4 hours (such as, for example, in the morning). In this manner, the user may not be inconvenienced with any alarm or notification associated with the scheduled calibration prompt from the analyte monitoring system, for example, while the user is asleep.

Referring back to FIG. 6, when the user performs an in vitro blood glucose measurement and enters that information into the analyte monitoring system (independent of the calibration schedule), assuming the blood glucose measurement can be used to successfully calibrate the sensor, the received blood glucose (or reference) measurement is accepted, and the sensor is calibrated based at least in part on the received blood glucose measurement (630), and the subsequent scheduled calibration time is automatically or semi-automatically (based on user confirmation) updated or otherwise modified to take into account the successful sensor calibration event (640). In other words, in embodiments of the present disclosure, when acceptable reference blood glucose measurement or calibration information (for example, from an in vitro blood glucose test) is received during the predetermined calibration time window for a particular scheduled calibration time period, the received glucose measurement may be accepted and used to calibrate the sensor, and the user is not thereafter prompted to perform another calibration during that predetermined calibration time window. In this manner, over the course of the sensor life (for example, five days, seven days or longer or shorter), any in vitro blood glucose measurements that the user performs (for reasons unrelated to sensor calibration requirement) and enters into the analyte monitoring system may be accepted as reference data for purposes of sensor calibration.

Embodiments further include dynamically shifting the scheduled time periods for performing the calibration (i.e., the calibration schedule for the particular sensor during in vivo use) such that, when a successful calibration has been performed, any remaining or subsequent scheduled calibration event is modified based on the successful calibration event. For example, referring back to FIG. 6, updating the calibration schedule (640) may include time shifting the subsequent scheduled calibration events so that they remain temporally spaced relative to each other, but are shifted in time based on the successful calibration performed.

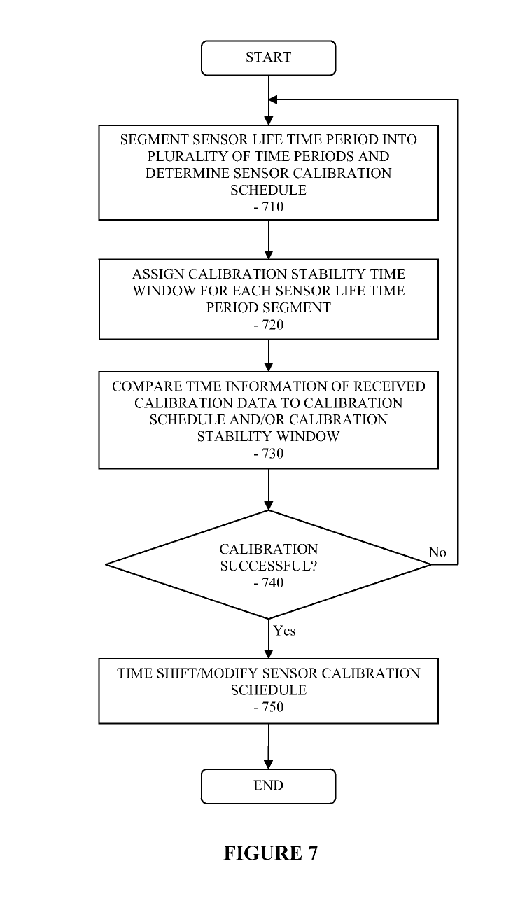

FIG. 7 is a flowchart illustrating another sensor calibration scheduling routine in accordance with another embodiment of the present disclosure. Referring to FIG. 7, in certain embodiments, a sensor life time period is segmented or divided into a plurality of time periods, and a sensor calibration schedule is provided for the sensor (710) over the sensor life (such as a seven day time period for a sensor with a seven day sensor life). The sensor system is also provided with a calibration schedule to calibrate the sensor over the sensor life. For example, upon sensor insertion at the start of the in vivo use, the sensor system may be programmed to prompt or notify the user to calibrate the sensor during certain times over the life of the sensor. By way of a non-limiting example, for the sensor with a seven day sensor life, the sensor system (e.g., receiver unit 104 (FIG. 1), may be programmed or programmable to prompt the user to enter or provide calibration data (such as the results of an in vitro blood glucose measurement) to calibrate the sensor at certain time intervals such as once every 24 hours (measured from time of sensor insertion), or progressively increased, such as the initial calibration scheduled at or around 6 hours from initial insertion, thereafter the second calibration scheduled at 12 hours from the initial scheduled calibration (or 18 hours measured from the initial sensor insertion), and the third calibration scheduled at 48 hours measured from the initial sensor insertion (or 30 hours from the second scheduled calibration), and so on. Each segment of the plurality of time periods of the sensor life time period may or may not coincide with the scheduled calibration time periods or events.

Referring to FIG. 7, each of the plurality of time periods of the sensor life is assigned a respective calibration stability time window (720). That is, embodiments include a first time period segment which includes the first 6 hours of the sensor use measured from the sensor insertion and during which the calibration stability window assigned may be a two hour period. The second time period segment may be assigned or defined as the subsequent 12 hours following the first time period of the sensor life, and assigned a calibration stability of six hour period. Referring to FIG. 7, when a calibration data (such as, for example, the results of an in vitro blood glucose measurement) is entered or provided to the sensor system by the user or from another medical device such as a blood glucose meter, it is determined whether the time of receipt of the calibration data falls within the assigned or determined calibration stability window (730).

If the time of receipt of the calibration data falls within the determined calibration stability window, then the calibration routine proceeds with the sensor calibration procedure (740), and thereafter if the calibration was successful, subsequent scheduled sensor calibration events are shifted based on when the successful sensor calibration is performed (750). That is, when the successful calibration occurred two hours prior to the scheduled sensor calibration, and the subsequent segmented sensor life time period is associated with a 12 hour stability window, the subsequent or the next scheduled calibration time is accordingly adjusted and the 12 hour stability window is updated to provide the user with a modified or updated stability time window, such that the 12 hour stability window is initiated or measured from the successful calibration event (e.g., two hours prior to the scheduled sensor calibration discussed above).

In the event the calibration procedure (740) is deemed unsuccessful, the routine may return to the beginning as shown in the figure. In certain embodiments, if the calibration procedure (740) is unsuccessful, the routine may not shift the subsequent scheduled sensor calibration events, and the next scheduled calibration time is not adjusted, i.e. the calibration routine continues as though the received calibration data was never received. In still certain embodiments, if the calibration procedure (740) is unsuccessful, the system may trigger an alarm or alert to inform or instruct the user to provide a new calibration data.

In this manner, embodiments include dynamically modifying the scheduled sensor calibration based on, for example, a predetermined or assigned sensor stability profile or time window which may be determined or modified in real time based on the analyte sensor signal response (for example, based on the signal stability profile), and/or based on one or more predetermined stability time window that is empirically or analytically determined for each sensor having a particular sensor life, or for each sensor in each manufactured sensor lot based on a particular manufacturing process. Moreover, in accordance with embodiments of the present disclosure, a convenient and robust sensor system is provided which does not require a strict adherence to prescheduled sensor calibration time periods and which may be modified during in vivo use.

In the manner described above, in one aspect of the present disclosure, dynamic variation or modification to the sensor calibration schedule based at least in part on the sensor stability profile is provided. While specific example values for the calibration stability duration for the different time periods of the sensor life is described above, within the scope of the present disclosure, the values provided above are solely for exemplary purposes, and are not intended to limit the scope of the various embodiments described herein. For example, the calibration stability duration for the first 12 hours of sensor life may be greater than two hours (such as four hours, five hours or more), depending upon, for example, the manufacturing conditions and/or tolerance of the analyte sensor and variation one or more parameters during the manufacturing process.

Additionally, in a further aspect of the present disclosure, the predetermined calibration stability duration for one or more of the time periods for the sensor may be associated with the sensor shelf life, such that older sensors (that have earlier manufacturing date) have greater sensor drift as compared to those sensors that were more recently manufactured. In this aspect, the associated calibration stability duration may be associated with the date of manufacture of the sensor, with, for example, the stability duration decreasing in range or configured to be tightened if the time period measured from the sensor manufacturing to when the sensor is being used (current time information determined by the data processing unit and/or the receiver unit) is greater than a predetermined time period.

The analyte monitoring systems may include an optional alarm system that, e.g., based on information from a processor, warns the patient of a potentially detrimental condition of the analyte. For example, if glucose is the analyte, an alarm system may warn a user of conditions such as hypoglycemia and/or hyperglycemia and/or impending hypoglycemia, and/or impending hyperglycemia. An alarm system may be triggered when analyte levels approach, reach or exceed a threshold value. An alarm system may also, or alternatively, be activated when the rate of change, or acceleration of the rate of change, in analyte level increase or decrease approaches, reaches or exceeds a threshold rate or acceleration. A system may also include system alarms that notify a user of system information such as system initialization, sensor initialization, sensor replacement, battery condition, sensor calibration, sensor dislodgment, sensor malfunction, etc. Alarms may be, for example, auditory and/or visual. Other sensory-stimulating alarm systems may be used including alarm systems which heat, cool, vibrate, or produce a mild electrical shock when activated.

Embodiments of the present disclosure also include sensors used in sensor-based drug delivery systems. The system may provide a drug to counteract the high or low level of the analyte in response to the signals from one or more sensors. Alternatively, the system may monitor the drug concentration to ensure that the drug remains within a desired therapeutic range. The drug delivery system may include one or more (e.g., two or more) sensors, a processing unit such as a transmitter, a receiver/display unit, and a drug administration system. In some cases, some or all components may be integrated in a single unit. A sensor-based drug delivery system may use data from the one or more sensors to provide necessary input for a control algorithm/mechanism to adjust the administration of drugs, e.g., automatically or semi-automatically. As an example, a glucose sensor may be used to control and adjust the administration of insulin from an external or implanted insulin pump.

One embodiment may include a method of determining a stability profile of an in vivo analyte sensor in fluid contact with a biological fluid, processing the determined stability profile in conjunction with calibration criteria for the analyte sensor, and modifying a predetermined sensor calibration schedule based on the processed stability profile.

In one aspect, determining the stability profile may include detecting the onset of a calibration routine initialization within a predetermined time period, performing stability analysis of the analyte sensor, and time shifting the calibration routine initialization to start at a time period different from the predetermined time period.

Time shifting may include executing the calibration routine following the stability analyte of the sensor.

Time shifting may include delaying the calibration routine initialization past the predetermined time period.

In one aspect, the analyte sensor may include a glucose sensor.

The determined stability profile may include a predetermined time period during which the analyte sensor is stable.

The determined stability profile may include acceptable condition for performing sensor calibration.

Time shifting the calibration routine initialization may include delaying subsequent scheduled calibration event.

In another embodiment, a method may include initializing an analyte sensor, activating a timer associated with the analyte sensor, the timer related to a stability profile of the analyte sensor, calibrating the analyte sensor based on a time corresponding reference data based at least in part on a predetermined calibration schedule, and modifying the calibration schedule.

Initializing the analyte sensor may include determining sensor stability.

The stability profile may include a predetermined time period associated with the sensor stability.

The predetermined calibration schedule may include a plurality time periods for performing calibration over the life of the sensor.

Modifying the calibration schedule may include time shifting the plurality of time periods for performing calibration.

The reference data may be associated with a time corresponding sensor data.

The reference data may be obtained from an in vitro blood glucose meter.

In yet another embodiment, a method may include detecting an input value associated with a reference data, verifying that an analyte sensor is within its calibration stability duration, calibrating the analyte sensor based on the detected input value, and time shifting one or more subsequent scheduled calibration events for the analyte sensor.

The reference data may be received from a blood glucose monitor.

Calibrating the analyte sensor may include determining a sensitivity value associated with the sensor.

The sensitivity may be determined based at least in part of the detected input value associated with the reference data.

The calibration stability duration may be associated with sensor manufacturing information.

The sensor manufacturing information may include a date of manufacture of the analyte sensor.

Various other modifications and alterations in the structure and method of operation of this invention will be apparent to those skilled in the art without departing from the scope and spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

1. A method, comprising:
determining a stability profile of an in vivo analyte sensor in fluid contact with a biological fluid, determining the stability profile including:
detecting the onset of a calibration routine initialization within a predetermined time period;
performing stability analysis of the analyte sensor; and
time shifting the calibration routine initialization to start at a time period different from the predetermined time period;
processing the determined stability profile in conjunction with calibration criteria for the analyte sensor; and
modifying a predetermined sensor calibration schedule based on the processed stability profile.

2. The method of claim 1, wherein time shifting includes executing the calibration routine following the stability analysis of the analyte sensor.

3. The method of claim 1, wherein time shifting includes delaying the calibration routine initialization past the predetermined time period.

4. The method of claim 1, wherein the analyte sensor includes a glucose sensor.

5. The method of claim 1, wherein the determined stability profile includes a predetermined time period during which the analyte sensor is stable.

6. The method of claim 1, wherein the determined stability profile includes acceptable condition for performing sensor calibration.

7. The method of claim 1, wherein time shifting the calibration routine initialization includes delaying a subsequent scheduled calibration event.

8. A method, comprising:
initializing an analyte sensor;
activating a timer associated with the analyte sensor, the timer related to a stability profile of the analyte sensor;
calibrating the analyte sensor based on a time corresponding reference data based at least in part on a predetermined calibration schedule including a plurality of time periods for performing calibration over the life of the sensor; and
modifying the calibration schedule to time shift the plurality of time periods for performing calibration.

9. The method of claim 8, wherein initializing the analyte sensor includes determining sensor stability.

10. The method of claim 8, wherein the stability profile includes a predetermined time period associated with the sensor stability.

11. The method of claim 8, wherein the reference data is associated with a time corresponding sensor data.

12. The method of claim 8, wherein the reference data is obtained from an in vitro blood glucose meter.

13. A method, comprising:
detecting an input value associated with a reference data;
verifying that an analyte sensor is within its calibration stability duration;
calibrating the analyte sensor based on the detected input value; and
time shifting the initiation of the one or more subsequent scheduled calibration events for the analyte sensor.

14. The method of claim 13, wherein the reference data is received from a blood glucose monitor.

15. The method of claim 13, wherein calibrating the analyte sensor includes determining a sensitivity value associated with the sensor.

16. The method of claim 15, wherein the sensitivity is determined based at least in part on the detected input value associated with the reference data.

17. The method of claim 13, wherein the calibration stability duration is associated with sensor manufacturing information.

18. The method of claim 17, wherein the sensor manufacturing information includes a date of manufacture of the analyte sensor.

19. An apparatus, comprising:
one or more processors;
a memory for storing instructions which, when executed by the one or more processors, causes the one or more processors to determine a stability profile of an in vivo analyte sensor in fluid contact with a biological fluid by detecting the onset of a calibration routine initialization within a predetermined time period, performing stability analysis of the analyte sensor, and time shifting the calibration routine initialization to start at a time period different from the predetermined time period, to process the determined stability profile in conjunction with calibration criteria for the analyte sensor, and to modify a predetermined sensor calibration schedule based on the processed stability profile.

20. The apparatus of claim 19, wherein the memory for storing instructions which, when executed by the one or more processors, causes the one or more processors to execute the calibration routine following the stability analysis of the analyte sensor.

22. The apparatus of claim 19, wherein the memory for storing instructions which, when executed by the one or more processors, causes the one or more processors to delay the calibration routine initialization past the predetermined time period.

23. The apparatus of claim 19, wherein the analyte sensor includes a glucose sensor.

24. The apparatus of claim 19, wherein the determined stability profile includes a predetermined time period during which the analyte sensor is stable.

25. The apparatus of claim 19, wherein the determined stability profile includes acceptable condition for performing sensor calibration.

26. The apparatus of claim 19, wherein the memory for storing instructions which, when executed by the one or more processors, causes the one or more processors to delay subsequent scheduled calibration event.

27. An apparatus, comprising:
one or more processors;
a memory for storing instructions which, when executed by the one or more processors, causes the one or more processors to initialize an analyte sensor, activate a timer associated with the analyte sensor, the timer related to a stability profile of the analyte sensor, calibrate the analyte sensor based on a time corresponding reference data based at least in part on a predetermined calibration schedule including a plurality of time periods for performing calibration over the life of the sensor, and modify the calibration schedule to time shift the plurality of time periods for performing calibration.

28. The apparatus of claim 27, wherein the memory for storing instructions which, when executed by the one or more processors, causes the one or more processors to determine sensor stability.

29. The apparatus of claim 27, wherein the stability profile includes a predetermined time period associated with the sensor stability.

30. The apparatus of claim 27, wherein the reference data is associated with a time corresponding sensor data.

31. The apparatus of claim 27, wherein the reference data is obtained from an in vitro blood glucose monitor.

32. An apparatus, comprising:
one or more processors;
a memory for storing instructions which, when executed by the one or more processors, causes the one or more processors to detect an input value associated with a reference data, verify that an analyte sensor is within its calibration stability duration, calibrate the analyte sensor based on the detected input value, and time shift the initiation of the one or more subsequent scheduled calibration events for the analyte sensor.

33. The apparatus of claim 32, wherein the memory for storing instructions which, when executed by the one or more processors, causes the one or more processors to determine a sensitivity value associated with the sensor.

34. The apparatus of claim 33, wherein the sensitivity is determined based at least in part of on the detected input value associated with the reference data.

35. The apparatus of claim 32, wherein the calibration stability duration is associated with sensor manufacturing information.

36. The apparatus of claim 32, wherein the sensor manufacturing information includes a date of manufacture of the analyte sensor.
